(19) United States
(12) Patent Application Publication
(10) Pub. No.: US 2020/0009553 A1
(43) Pub. Date: Jan. 9, 2020

(54) MEDICAL TEST TUBE

(71) Applicant: Felix ROTH, Arbon (CH)

(72) Inventor: Felix ROTH, Arbon (CH)

(21) Appl. No.: 16/483,838

(22) PCT Filed: Feb. 6, 2018
(86) PCT No.: PCT/EP2018/052956

§ 371 Date: Aug. 6, 2019

(30) Foreign Application Priority Data
Feb. 8, 2017 (CH) 145/17

(51) Int. Cl. B01L 3/00

(52) U.S. Cl. CPC B01L 3/50825; B01L 3/5021; B01L 2300/0858; B01L 2300/042; B01L 2300/046; B01L 2200/026

(57) ABSTRACT

A medical test tube comprises a tube-shaped container having a substantially cylindrical container wall enclosing a container interior, an upper filling opening and a lower container base, and a container cover covering the upper filling opening. In the container, a sample removal channel is arranged that has an upper sample removal opening and a lower sample removal opening. The sample removal channel leads through the lower sample removal opening in the region of the container base into the container interior. To remove a sample, the upper sample removal opening is arranged laterally in the upper region in the container wall so that when the container cover is closed, the sample can be removed through the upper sample removal opening. A deflection region of the sample removal channel abuts the sample receiving opening and has a rounded upper deflection surface to make it easier to introduce the sample removal tube.

### TECHNICAL FIELD

The invention relates to a medical tube for the preparation of a biological sample by means of density gradient centrifugation or passive sedimentation.

### TECHNICAL BACKGROUND

Centrifugation is a conventional method for fractionating a sample. This method is often used to separate a target fraction with a higher density from the surrounding medium and to purify and concentrate this target fraction at the same time. What is known as density gradient centrifugation is used, for example, in order to separate motile sperm from non-motile sperm. This can also remove unwanted contaminants such as bacteria and viruses from the target fraction.

In order to separate the pellet (precipitate with the target fraction) from the supernatant, one of two conventional methods is usually used. In the first method, the supernatant is aspirated until only the pellet with the target fraction remains, which is subsequently processed further. In the second method, a needle is pushed through the supernatant in order to reach the pellet directly and to aspirate it off. However, both methods run the risk that contaminants from the supernatant will be re-introduced into the target fraction. This is a particular problem when purifying sperm from HIV-positive men, for example, because this could re-contaminate the target fraction with HIV.

In order to reduce re-contamination of this type, DE60034720 proposes a medical tube for purifying and centrifugation sperm which comprises a substantially tapered section at the bottom which contains the pellet with the target fraction or the purified sperm after centrifugation. The tapered section is then separated from the rest of the medical tube at a predetermined breaking point so that the target fraction can subsequently be processed further. When separating the tapered section, however, there is a risk that the whole of the supernatant will spill out. In addition, when separating the target fraction, there is an increased risk of introducing contaminants from the immediate surroundings.

In order to reduce re-contamination, US 2005 064579 describes a medical tube with an insert which can be placed into a conventional medical tube. The insert is provided with a central suction tube which extends into the region of the bottom of the medical tube so that after centrifugation, the target fraction or the pellet can be sucked out. The disadvantage with the insert is that when applying the sample between the suction tube and the wall of the medical tube, the upper opening of the suction tube may become contaminated because of the limited space, which again could result in re-contamination when removing the target fraction.

EP 2 208 540 describes a medical tube in which an insert forms a dividing wall in order to divide an interior of the tube into two compartments. In all of the embodiments, the two compartments are open at the end face of the tube in order to take in samples and to remove them again after centrifugation. For this purpose, a cap sealing the two openings has to be removed again and the risk of re-contamination arises. In order to ensure the necessary pressure equilibration in all possible cases when the cap is closed in the two compartments, the two compartments may be provided with ventilation openings in the upper region of the medical tube.

A sealed and sterile medical tube for purifying a biological sample is known from EP 1 773 496; its cap is provided with a sample removal opening and a filling opening. The sample removal opening is provided with a needle which extends into the region of the bottom of the medical tube for the removal of a sample. The filling opening is provided with a pierceable septum. In order to allow the sample to be added and removed with the cap being closed, the cap is provided with a pressure equilibration opening comprising a filter. The cap is relatively complicated in construction and requires many assembly steps, which considerably increases the production costs. A further disadvantage lies in the fact that in the case of a density gradient centrifugation, the media for forming the density gradients have to be added through the filling opening with the cap in place, because otherwise, when the cap was closed, the density gradient could be stirred up. Similar medical tubes are known from WO 2005/039773, U.S. Pat. No. 7,717,274 and WO 2002/098566.

GB 1 064 901 describes a tube which has a channel in the side wall which runs from the deepest point in the tube bottom to the top at the end face. In this tube as well, there is a risk of re-contamination.

### DESCRIPTION OF THE INVENTION

An objective of the invention is to overcome the above problems, and in particular to efficiently prevent re-contamination. In addition, the medical tube should be easy to use and produce.

This objective is achieved by means of a medical tube with the features of claim 1. The medical tube for the preparation of a biological sample by means of density gradient centrifugation and/or passive sedimentation comprises a tubular container with an substantially cylindrical container wall, an upper filling opening and a lower container bottom, and a container cap which covers the upper filling opening, in particular a screw cap. The container wall encompasses a container interior. A sample removal channel disposed in the container and comprises an upper sample removal opening and a lower sample removal opening, wherein the sample removal channel opens into the container interior through the lower sample removal opening in the region of the container bottom. Apart from the lower sample removal opening, the sample removal channel is sealed from the container interior. The upper sample removal opening is disposed laterally in the upper region in the container wall for removal of a sample by means of a piece of sample removal tubing, so that the sample can be removed through the upper sample removal opening when the container cap is closed. A deflection region of the sample removal channel which is connected to the sample removal opening has a rounded upper deflection surface in order to facilitate introduction of the piece of sample removal tubing, so that the sample removal channel is configured so as to be closed in the direction of the filling opening. Preferably, the sample removal opening is disposed in the upper region of the medical tube, preferably in the upper quarter of the container wall or directly below the container cap.

A medical tube or centrifugation tube of this type may thus comprise a conventional screw cap without any openings. The media for the various layers of the density gradient and consequently the sample, for example a sperm sample, can be added through the filling opening of the medical tube when the container cap is removed. Contamination of the sample removal channel is therefore not possible. Subsequently, the medical tube is closed with the cap and centrifuged. After centrifugation is completed, the pellet with the purified target fraction can be removed from the container bottom of the medical tube guiding a thin piece of removal tubing laterally through the sample removal opening into the sample removal channel towards the pellet. Re-contamination of the target fraction with contaminants remaining in the upper layers of the density gradient is avoided since the removal pipe does not come into contact with it, because the sample removal channel is sealed from the interior. In addition, the risk of any possible contamination of the environment (for example with samples contaminated with HIV) is reduced, because the tube cap no longer has to be opened for the removal procedure.

In some embodiments, the container may comprise a temporary closure element which covers the upper sample removal opening. This may be removed after centrifugation is complete, or before removal of the sample. Preferably, the closure element does not close off the sample removal opening in a gas-tight manner, so that equilibration of the pressure in the sample removal channel is possible at any time. Thus, for example, the container cap and the upper container edge may be configured in a manner such that pressure equilibration of the container interior is possible. As an example, to this end, the container edge may comprise a thin or fine indentation or a pressure equilibration notch. The indentation or the notch is usually narrow in configuration, so that it is in fact air-permeable but, for example if the tube is tipped over, it is impervious to liquids because of capillary action.

In some embodiments, the closure element may be an opening slide for opening and closing the upper sample removal opening. The opening slide may be configured as a sleeve which at least partially encompasses the container, which has an opening which can be lined up with the opening slide in order to open the sample removal opening, for example by turning about a longitudinal axis of the medical tube. In order to move the opening slide easily from a closed position into an open position, the opening slide and the container may be provided with an abutment which abut each other when the opening slide is completely open.

In some embodiments, the opening slide and the container may comprise catch means which lock the opening slide in an open position and in a closed position.

In some embodiments, the closure element may be a tear-off sleeve which covers the sample removal opening, which can be at least partially torn off to open the sample removal opening and which comprises predetermined breaking points or predetermined tearing points along a tear seam.

In some embodiments, the closure element may comprise a thinned area which covers the sample removal opening which can be pierced by means of a sample removal means.

In some embodiments, the closure element may be recessed into the container wall so that external surfaces of the container wall and of the closure element align with each other, at least underneath the closure element.

Preferably, the medical tube is a multi-part injection moulded article produced from plastic by injection moulding. In this respect, the closure element may be a separate injection moulded part, for example in the case of an opening slide or in the case of a closure element connected via predetermined tearing points, or it may be a part which is integrally overmoulded onto the container cap or onto the upper container part, for example in the case of a closure element which is connected via predetermined tearing points or a closure element in the form of a thinned area.

In some embodiments, the container may be produced in two parts from an upper container part and a lower container part, wherein the upper container part and the lower container part can be brought into mutual engagement and the upper container part forms the upper sample removal opening and the upper deflection surface. The upper container part and the lower container part may be able to be brought into mutual engagement by means of circumferential catch means, in particular a circumferential bead and a circumferential groove.

In some embodiments, a rotation lock may be disposed between the upper container part and the lower container part, preferably in the form of at least one recess and a projection which is complementary thereto.

In some embodiments, the upper container part may form the sample removal channel which extends into the container interior. The sample removal channel may be configured as a thin pipe or tube which is freestanding in the container interior, which is connected to the upper container part and which extends downwards to the container bottom. The sample removal channel may thus be overmoulded onto the upper container part, or the sample removal channel may be constructed in two parts, wherein an upper, first channel part is formed by the upper container part and a lower, second channel part is formed by a tube which extends into the container interior which is securely retained in the upper container part.

Preferably, the inner surfaces of the upper, first channel part are flush with the inner surfaces of the lower, second channel part in the region of transition to the lower, second channel part, so that sample removal means, for example a piece of sample removal tubing, does not get stuck when being introduced. This means that in the transition region, the lower, second channel part could also have a larger internal cross section than the upper, first channel part.

The medical tube may be produced in several parts from plastic simply by means of injection moulding.

In some embodiments, the sample removal opening may be disposed in the upper region of the medical tube, preferably in the upper third of the tube wall, underneath the cap. In this regard, as a rule, the sample removal opening is not covered by the cap. However, it is also possible for the container cap to be provided with a closure element which extends downwardly, for example in the form of a sleeve, which extends over the sample removal opening and covers it. In order to remove the pellet following centrifugation, the container cap may be removed, so that the sample removal opening is exposed. Preferably, the closure element is also connected to the cap via a predetermined breaking point, so that it can be removed from the medical tube without having to remove the cap.

The medical tube may be produced as a disposable medical tube.

Furthermore, the invention concerns the use of a medical tube as described above for selection and purification of sperm by means of density gradient centrifugation and/or passive sedimentation.

A method for the purification of a biological sample, for example sperm, may therefore contain the following steps:
preparing a sterile medical tube as described above;
filling and constructing a density gradient in the interior of the medical tube through the filling opening;
applying, the biological sample through the filling opening onto the uppermost layer of the density gradient and attaching the container cap;
centrifugation the medical tube with the loaded sample until the desired pellet with the target fraction is formed at the container bottom;
removing or opening the closure element in order to open the sample removal opening;
introducing a piece of sample removal tubing into the sample removal channel to reach the pellet, with the container cap in place;
removing the pellet through the piece of sample removal tubing; and
disposing of the medical tube.

### BRIEF DESCRIPTION OF THE FIGURES

The invention will now be explained in more detail with the aid of exemplary embodiments in connect with the accompanying drawings. In the figures:

FIG. 1 shows a section of a first exemplary embodiment of a medical tube (without cap);

FIG. 2 shows an upper and a lower container part of the exemplary embodiment of FIG. 1, in an exploded perspective view;

FIG. 3 shows an upper container part of the exemplary embodiment of FIG. 1 in a perspective view from below;

FIG. 4 shows a perspective view of a second exemplary embodiment of a medical tube (without cap);

FIG. 5 shows a sectional view of the upper region of the exemplary embodiment from FIG. 4;

FIG. 6 shows two perspective views of the upper container part of the exemplary embodiment of FIG. 4;

FIG. 7 shows an exploded view of a third exemplary embodiment of a medical tube with an opening slide;

FIG. 8 shows a sectional view of the exemplary embodiment of FIG. 7;

FIG. 9 shows perspective views of the upper region of the exemplary embodiment of FIG. 7, wherein (a) is in the open position and (b) is in the closed position; and

FIG. 10 shows a perspective view of the upper container part with opening slide.

### WAYS OF CARRYING OUT THE INVENTION

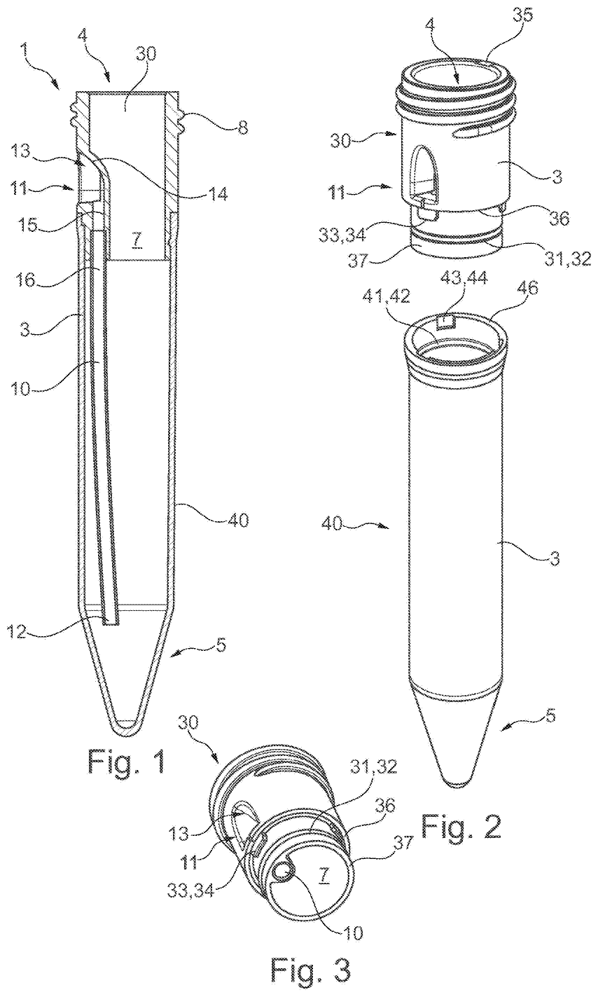

FIGS. 1 to 3 show a first exemplary embodiment of a medical tube (without cap) for the preparation of a biological sample by means of density gradient centrifugation and/or passive sedimentation. FIG. 1 shows the medical tube in a sectional view. FIG. 2 shows an upper container part 30 and a lower container part 40 in an exploded perspective view. FIG. 3 shows the upper container part 30 in a perspective view from below.

The medical tube forms an substantially cylindrical or tubular container 1 with a thin container wall 3 surrounding a container interior 7. A filling opening 4 is formed at the top. At the bottom, the container 1 is closed with a conically tapering container bottom 5. The filling opening 4 can be closed by means of a container cap preferably a screw cap. In the exemplary embodiment show, an external thread 8 for a screw cap is formed around the filling opening 4. Preferably, the outer contour corresponds to a standard 15 mL or 50 mL laboratory test tube (also known by the name “BD Falcon™ tubes) and therefore fits into conventional centrifuges.

A sample removal channel 10 is formed in the container interior 7. The sample removal channel 10 is segregated from the container interior 7 and only at the lower end has a lower sample removal opening 12 which opens into the interior 7 of the medical tube in the region of the container bottom 5. At the upper end, the sample removal channel 10 has an upper sample removal opening 11 which is disposed laterally in the container wall 3 and via which the sample removal channel 10 opens into the environment outside the medical tube. The sample removal channel 10 serves to remove a sample from the container bottom 5 following centrifugation. To this end, a thin piece of sample removal tubing may be guided down to the pelletized sample without coming into contact with or stirring the medium lying above the pellet. Because the sample removal channel 10 opens laterally via the upper sample removal opening 11 in the container wall 3, a sample may be removed from the container bottom 6 without having to remove the container cap 4. Any re-contamination of the sample is thus prevented.

The dimensions of the sample removal channel 10 are such that a thin piece of sample removal tubing of 1 mm to 2.5 mm can be guided through the sample removal channel 10 down to the tube bottom 6 or down to the pellet. This means that the internal diameter preferably between 1.5 mm and 4 mm.

In order to easily introduce a piece of sample removal tubing into the sample removal channel 10, the sample removal channel 10 has a deflection region 13 at the upper end. In this deflection region 13, a rounded deflection surface 14 is formed in a manner such that a laterally introduced piece of sample removal tubing can be deflected downwardly at the deflection surface 14 in the direction of the container bottom and can be guided into the sample removal channel 10. The upper sample removal opening 11 may be formed as an elongate hole in the form of an archway.

The medical tube of FIGS. 1 to 3 comprises a two part container 1 with an upper container part 30 and a lower container part 40. The two container parts 30, 40 are pushed into one another in a rotation-proof manner. The rotation lock 33, 43 is formed by means of projections 34 which fit in complementary notches 34, wherein in the embodiment shown, the notches 44 are formed on the inner side in the upper edge 46 of the lower container part 40. The complementary projections 34 are formed at the upper container part 30 below a circumferential shoulder 36 on a skirt 37 which extends downwardly. The upper container part 30 with the skirt 37 is pushed into the lower container part 40. In order to be retained in it, the upper container 30 comprises a locking means 31 in the skirt 37 in the form of a circumferential groove 32. The lower container part 40 has a complementary locking means 41 on the inner side, in the form of a circumferential bead 42. When the upper and lower container parts are assembled, the shoulder 36 of the upper container part lies on an upper edge 46 of the lower container part.

The sample removal channel 10 is formed in two parts with an upper, first channel part 15 and a lower, second channel part 16. The upper, first channel part 15 is integrated into the upper container part 30 and also forms the deflection region 13 with the deflection surface 14. The lower, second channel part 16 (not shown in FIGS. 2 and 3) is a narrow tube which is fixed in an opening of the upper charnel part 15. Preferably, the inner surfaces of the upper, first channel part 15 are flush with the inner surfaces of the lower, second channel part 16 in the transition region to the lower, second channel part 16, so that sample removal means, for example a piece of sample removal tubing, does not get stuck when being introduced. This means that the lower, second channel part 16 could also have a larger internal cross section than the upper, first channel part 15 in the transition region.

During centrifugation or when removing a sample, pressure differences between the interior of the container 7 and the environment may occur. These can be balanced out even when the cap is closed via a pressure equilibration notch 35 in the upper edge of the container. This may be narrow in configuration so that it is indeed permeable to air but, for example in the event that the tube is tipped over, it will be impermeable to liquid because of capillary action.

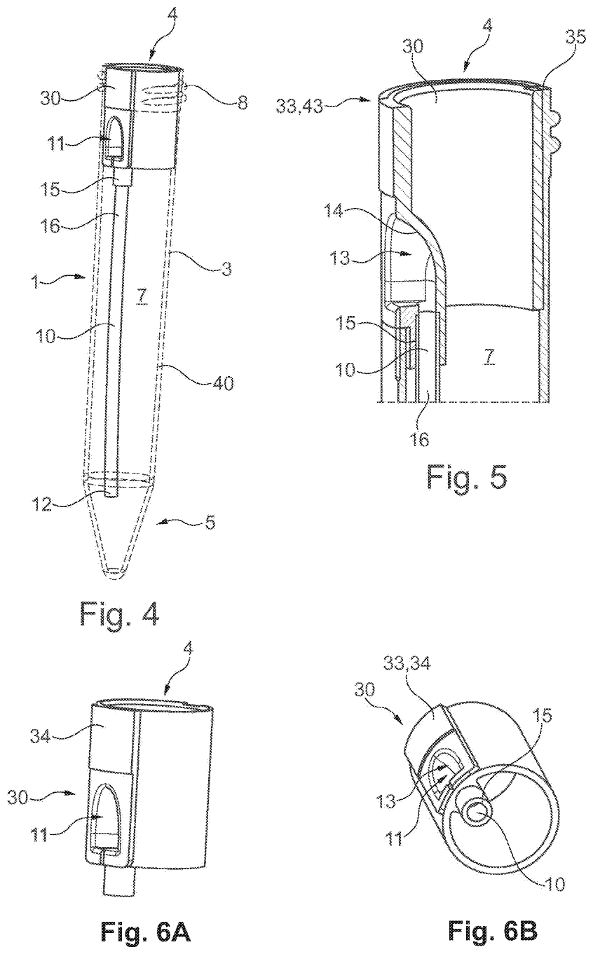

A second exemplary embodiment of a medical tube (without cap) is shown in FIGS. 4 to 6. FIG. 4 shows the medical tube in a perspective view with a transparent lower container part. FIG. 5 shows a sectional view of the upper region of the medical tube. FIG. 6 shows two perspective views of the upper container part.

In contrast to the exemplary embodiment of FIG. 1, in particular, the rotation lock is configured in a different manner. A substantial portion of the upper container part 30 with the upper sample removal opening 11 is pushed into the lower container part 40 and together with it forms the upper edge of the container 1. In the region of the upper sample removal opening 11, it is pushed radially outwardly and forms a projection 34 of the rotation lock which interlocks into a complementary notch or an approximately rectangular recess of the lower container part 40. The external thread 8 for the screw cap is formed on the lower container part 40.

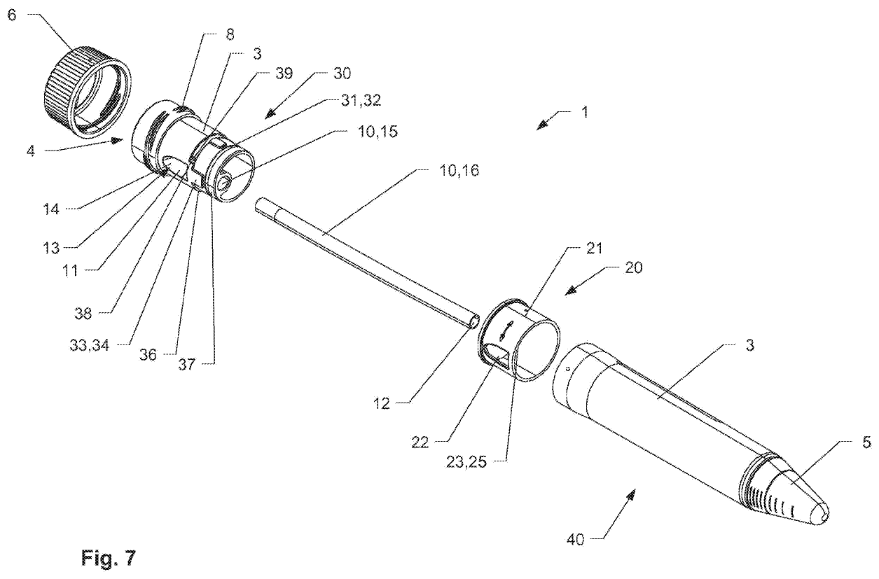

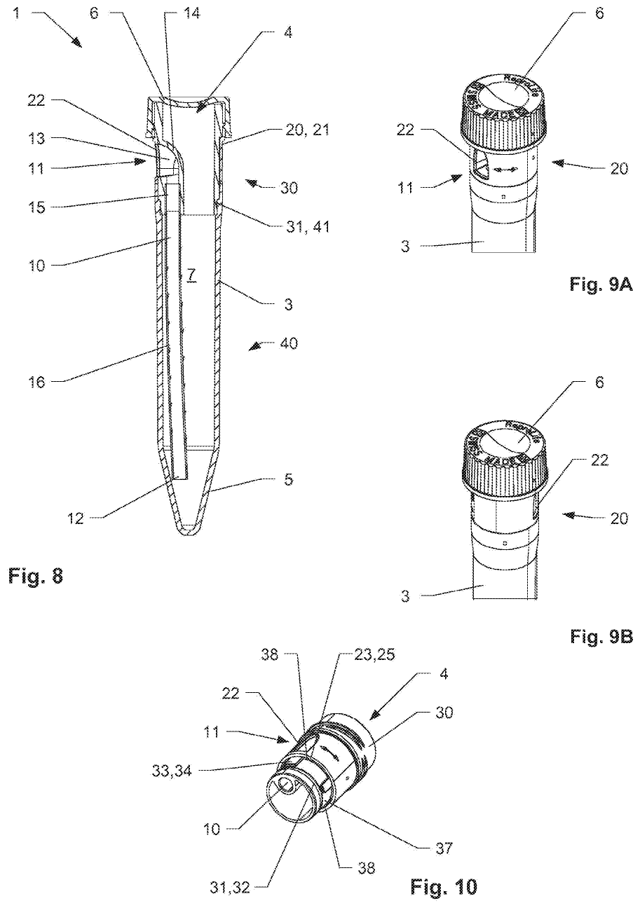

FIGS. 7 to 10 show a third embodiment of a medical tube with a container cap 6. FIG. 7 shows an exploded view. FIG. 8 shows a sectional view. FIG. 9 shows a section of the medical tube with an opening slide 20 (a) in an open position and (b) in a closed position. FIG. 10 shows a perspective view of the upper container part with the opening slide.

As was the case with the exemplary embodiment in FIG. 1, the medical tube of FIG. 7 has a container cap 6, an upper container part 30 which forms the upper, first channel part 15 with the upper sample removal opening 11, a lower, second channel part 16 in the form of a narrow tube and a lower container part 40. In contrast to the exemplary embodiment of FIG. 1, the exemplary embodiment of FIG. 7 has an additional closure element 20 in the form of an opening slide for opening and closing the upper sample removal opening 11.

The opening slide 20 is substantially configured as a sleeve 21 and encompasses the upper container part 30, which is correspondingly tapered in configuration in this region. The outer surface of the sleeve 21 and the outer surface of the lower container part 40 are aligned with each other.

The opening slide 20 has an opening 22 with dimensions which cover the dimensions of the upper sample removal opening 11. By turning the opening slide 20 about the longitudinal axis of the medical tube, the opening 22 of the opening slide 20 is brought into alignment with the sample removal opening 11 in order to remove the sample after centrifugation is complete, without having to remove the container cap 6. FIG. 9(a) in this regard shows the open position of the medical tube in which the two openings are in alignment. FIG. 9(b) shows the closed position.

In order to facilitate operation, the container 1 or the upper container part 30 and the opening slide 20 may respectively be provided with an abutment 23, 38 which define the open or closed position. In the two positions, the opening slide can be locked by means of catch means 25, 39. In the exemplary embodiment shown, the catch means on the opening slide are configured as a projection 25 and as a corresponding notch 39 on the container.

The medical tubes described above with a sample removal channel opening laterally in the container wall may be used for density gradient centrifugation of a biological sample, for example for the purification and separation of a sperm sample. To this end, initially, the container cap is removed and several layers of a density gradient are built up in the container interior of the medical tube. Next, the sample is introduced, the container cap is put on and the medical tube with the sample is ready for centrifugation. After centrifugation is complete, the target fraction of the sample is located in the pellet at the container bottom of the medical tube and can be removed directly from the container bottom. To this end, the sample removal opening is opened and a piece of sample removal tubing can be guided through the sample removal channel to the pellet in the container bottom with the container cap being closed. The piece of sample removal tubing thus does not come into contact with any contaminants from the upper layers of the density gradient and from the supernatant of the sample, and re-contamination is efficiently prevented. The pellet with the target fraction may, for example, be aspirated through the piece of sample removal tubing using a syringe. Similarly, the medical tube may be used for any subsequent washing steps. To this end, the target fraction that has been removed is transferred into a new tube, supplemented with a washing, solution, and after centrifugation or passive sedimentation in the manner described above, the target fraction is removed again.

The configuration of the above sample removal channel with the deflection region, the two-part nature of the container or the opening slide may be considered to be inventions in their own right together with the laterally open sample removal channel.

### LIST OF REFERENCE NUMERALS

1 tubular container
3 container wall
4 filling opening
5 container bottom
6 container cap
7 container interior
8 external thread
10 sample removal channel
11 upper sample removal opening
12 lower sample removal opening
13 deflection region
14 deflection surface
15 first channel part
16 second channel part
20 closure element/opening slide
21 sleeve
22 opening
23 abutment
25 catch means, projection
30 upper container part
31 catch means
32 groove
33 rotation lock
34 projection
35 pressure equilibration notch
36 shoulder
37 skirt
38 abutment
39 catch means, notch
40 lower container part
41 catch means
42 bead
43 rotation lock
44 recess

1-15. (canceled)

16. A medical tube for the preparation of a biological sample by density gradient centrifugation and/or passive sedimentation, the medical tube comprising a tubular container with an substantially cylindrical container wall, an upper filling opening and a lower container bottom, and a container cap which covers the upper filling opening; wherein the container wall encompasses a container interior; wherein a sample removal channel is disposed in the container and comprises an upper sample removal opening and a lower sample removal opening, wherein the sample removal channel opens into the container interior through the lower sample removal opening in the region of the container bottom, wherein the upper sample removal opening is disposed laterally in the upper region in the container wall for removal of a sample by means of a piece of sample removal tubing, so that the sample is removable through the upper sample removal opening when the container cap is closed, and wherein a deflection region of the sample removal channel which is connected to the sample removal opening has a rounded upper deflection surface in order to facilitate introduction of the piece of sample removal tubing.

17. The medical tube of claim 16, wherein the container comprises a closure element which covers the upper sample removal opening.

18. The medical tube of claim 17, wherein the closure element is an opening slide for opening and dosing the upper sample removal opening.

19. The medical tube of claim 18, wherein the opening slide is a sleeve which encompasses the container, which has an opening which can be lined up with the opening slide in order to open the sample removal opening.

20. The medical tube of claim 18, wherein the opening slide and the container are respectively provided with an abutment which abut each other when the opening slide is completely open.

21. The medical tube of claim 18, wherein the opening slide and the container comprise catch means which lock the opening slide in an open position and in a closed position.

22. The medical tube as claimed in claim 17, wherein the closure element is a tear-off sleeve which covers the sample removal opening, which can be at least partially torn off to open the sample removal opening and which comprises predetermined breaking points or predetermined tearing points along a tear seam.

23. The medical tube of claim 17, wherein the closure element (20) is recessed into the container wall (2) so that external surfaces of the container wall (2) and of the closure element (20) align with each other, at least underneath the closure element.

24. The medical tube of claim 16, wherein the container is produced in two parts from an upper container part and a lower container part, wherein the upper container part and the lower container part can be brought into mutual engagement and the upper container part forms the upper sample removal opening and the upper deflection surface.

25. The medical tube of claim 23, wherein the upper container part and the lower container part can be brought into mutual engagement by circumferential catch means.

26. The medical tube of claim 23, wherein a rotation lock is disposed between the upper container part and the lower container part.

27. The medical tube of claim 23, wherein the upper container part forms the sample removal channel which extends into the container interior.

28. The medical tube of claim 23, wherein the sample removal channel is constructed in two parts, wherein an upper, first channel part is formed by the upper container part and a lower, second channel part is formed by a tube which extends into the container interior and which is securely retained in the upper container part.

29. The medical tube of claim 27, wherein the inner surfaces of the upper, first channel part are flush with the inner surfaces of the lower, second channel part in the region of transition to the lower, second channel part.

30. The medical tube of claim 16, wherein the upper sample removal opening is disposed in the upper region of the medical tube either in the upper quarter of the container wall or directly below the container cap.
